(19) United States
(12) Patent Application Publication
(10) Pub. No.: US 2010/0250548 A1
(43) Pub. Date: Sep. 30, 2010

(54) INFORMATION TERMINAL EQUIPPED WITH CONTENT SEARCH SYSTEM

(75) Inventor: Hong-bae Kim, Yongin-si (KR)

Correspondence Address: ROTHWELL, FIGG, ERNST & MANBECK, P.C., 1425 K STREET, N.W., SUITE 800, WASHINGTON, DC, 20005, US

(73) Assignee: HIEL LEADERS TOMORROW CORP., Daejeon-si (KR)

(21) Appl. No.: 12/438,507

(22) PCT Filed: Aug. 20, 2007
(86) PCT No.: PCT/KR07/03959

§ 371 Date: Feb. 23, 2009

(30) Foreign Application Priority Data
Aug. 23, 2006 (KR) 10-2006-0080088

(51) Int. Cl. G06F 17/30

(52) U.S. Cl. 707/741; 707/769; 707/E17.014; 707/E17.002; 707/E17.005

(57) ABSTRACT

An information terminal equipped with a content search system is provided. The information terminal receives a query from a user, analyzes the query, determines a search type on the basis of the result of the analysis, searches for content items corresponding to the query according to the search type, and displays the content items, wherein the information terminal receives a content item selected by the user from the displayed content items, and reads and provides content corresponding to the content item from the content database. Therefore, the information terminal organically combines an information search technique with a content providing technique so that a user can quickly and conveniently search for his or her desired content.

### TECHNICAL FIELD

The present invention relates to an information terminal equipped with a content search system, and more particularly, to a technique for providing content selected by a user from a search result for the user's query.

### BACKGROUND ART

Recently, various types of search engines having a function of quickly and correctly searching for a large amount of various information are being widely used in various technical fields. The search engines have been used in a large computing environment, which requires high process performance, a large storage capacity, stable network performance, integrated system management, etc., and have been evolved to a web portal which can search for information through the Internet.

However, with the development and increased storage capacity of information devices, portable information terminals are widely distributed and are required to quickly search for a large capacity of information. Conventional information search methods can be generally classified into three types: a sequential search method, a multi-step search method, and an intermediate-word search method. The sequential search method is to find out a desired word by searching a database for words having the same syllables sequentially from the first syllable of the desired word to the last syllable of the desired word. The multi-step search method is to acquire desired information by searching for data sequentially from a large class to a small class. The intemediate-word search method is to directly acquire information having a part of a desired word from a database. The three conventional methods allow a user to easily search for his or her desired information, but have a limit in a quick, convenient search of a large amount of information.

Accordingly, a technique for combining an information search technique with a content providing technique so that a user can more easily access content and quickly and conveniently search for a large amount of information is needed. In order to meet the need, an information terminal equipped with a content search system for allowing a user to easily access content by systematically combining an information search technique with a content providing technique is proposed.

### DISCLOSURE OF INVENTION

### Technical Problem

The present invention provides an information terminal equipped with a content search system for a user to easily access content by combining an information search technique with a content providing technique.

### Technical Solution

According to an aspect of the present invention, there is provided an information terminal equipped with a content search system, the information terminal receiving a query from a user through a user interface, analyzing the query to determine a search type, searching for and displaying content items corresponding to the query from an index information database according to the search type, receiving a content item selected by the user among the content items, and reading and providing content corresponding to the content item from a content database.

Additional features of the invention will be set forth in the description which follows, and in part will be apparent from the description, or may be learned by practice of the invention.

### ADVANTAGEOUS EFFECTS

An information terminal equipped with a content search system according to the present invention combines an information search technique with a content providing technique so that a user can quickly and conveniently search for his or her desired content using the information terminal.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of an information terminal equipped with a content search system, according to an embodiment of the present invention;

FIG. 2 is a block diagram of a content search system equipped in the information terminal illustrated in FIG. 1, according to an embodiment of the present invention;

FIG. 3 is a flowchart of a content search method according to an embodiment of the present invention which is performed by the content search system illustrated in FIG. 2; and

FIG. 4 is a flowchart of an index information storage method according to an embodiment of the present invention which is performed by the content search system illustrated in FIG. 2.

### BEST MODE FOR CARRYING OUT THE INVENTION

The present invention discloses an information terminal equipped with a content search system including: a manipulation unit allowing a user to input a query; a display unit displaying a search result and content; a memory storing an index information database storing index information and a content database storing content; and a controller controlling an entire operation of the information terminal, executing the content search system, performing searching for content items for a query received from the user through the manipulation unit, and displaying the content items through the display unit, wherein the content search system includes: a query input unit providing a user interface for allowing the user to input the query, and receiving the query from the user through the user interface; a query analysis unit analyzing the query received from the user; an information search unit including a plurality of type-based search agents for performing type-based search with reference to the index information database, a search type determining unit determining a search type from the result of the analysis, a search agent management unit executing and managing a type-based search agent corresponding to the search type, and a search result output unit assigning priorities to content items searched by the type-based search agent and outputting the content items according to the priorities; a search result display unit displaying the content items according to the priorities, providing a user interface for allowing the user to select a content item from among the content items, and receiving the content item selected by the user through the user interface; and a content providing unit reading and providing content corresponding to the content item selected by the user, from the content database.

It is to be understood that both the foregoing general description and the following detailed description are exemplary and explanatory and are intended to provide further explanation of the invention as claimed.

### MODE FOR THE INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

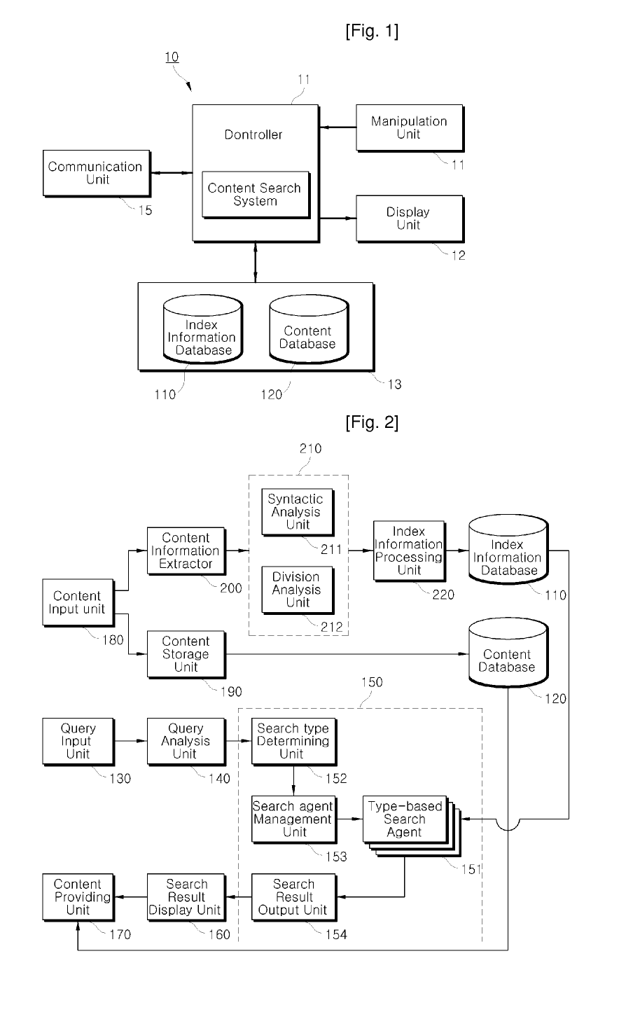

FIG. 1 is a block diagram of an information terminal 10 equipped with a content search system, according to an embodiment of the present invention. Referring to FIG. 1, the information terminal 10 includes a manipulation unit 11, a display unit 12, a memory 13, and a controller 14. The manipulation unit 11 is used to allow a user to input a query. That is, a user inputs a query by manipulating the manipulation unit 11. The display unit 12 is used to output a variety of screens. Search results (that is, content items) and contents are displayed through the display unit 12.

The memory 13 may be a storage unit, such as a hard disc, CD, flash memory, etc., for storing various data. The memory 13 includes an index information database 110 and a content database 120. The index information database 110 structurizes and stores index information. A method for storing index information in the index information database 110 will be described in detail later. The content database 120 stores various online contents, such as music information of a MP3, map information of a navigation system, word information of an electronic dictionary, moving picture information, telematics information, ubiquitous information, etc. A method of storing contents in the content database 120 will be described in detail later.

The controller 14 controls the entire operation of the information terminal 10. In detail, the controller 14 executes the content search system to search for content items for a query received through the manipulation unit 11, and controls the display unit 12 to display the results of the search. Accordingly, in the information terminal 10 equipped with the content search system, when a user inputs a query through the manipulation unit 11, the controller 14 executes the content search system to search for content items for the query, and provides the results of the search to the user through the display unit 12. A reference number 15 in FIG. 1 represents a communication unit for communicating with a server.

Now, the content search system equipped in the information terminal 10 as constructed above will be described in detail with reference to FIG. 2. FIG. 2 is a block diagram of the content search system equipped in the information terminal 10 illustrated in FIG. 1, according to an embodiment of the present invention. The content search system is a software type content search engine which is performed by an information terminal, such as a cellular phone, PMP, karaoke machine, telematics machine, ubiquitous terminal, etc. Referring to FIG. 2, the content search system includes a query input unit 130, a query analysis unit 140, an information search unit 150, a search result display unit 160, and a content providing unit 170. In the specification, the information terminal can provide various content information, such as a cellular phone, PDA, PMP, navigation system, karaoke machine, telematics device, ubiquitous terminal, etc.

The query input unit 130 provides a user interface (UI) for receiving queries, and receives a query from a user through the user interface. For example, when the content search system is applied to a navigation system, a user can input a place name through the query input unit 130. When the content search system is applied to a karaoke machine, a user can input a song's name through the query input unit 130. For example, when the content search system is applied to an electronic dictionary, a user can input a word through the query input unit 130.

The query analysis unit 140 analyzes the query which is input through the query input unit 130. For example, if the query is “tw”, the query analysis unit 140 can analyze the query into two-way modes. In one way as syllable based, it is analyzed into the query that can search words, like “tower, toward, . . . ”, having a letter ‘t’ in the first syllable and a letter ‘w’ in the second syllable. In the other way as word based, it is analyzed into the query that can search phrases, like “top world, total war, this-worldly . . . ”, consisting of the first keyword starting with a letter ‘t’ and the second or third keyword starting with a letter ‘w’.

The information search unit 150 determines a search type on the basis of the results of the analysis, searches for content items corresponding to the query from the index information database 110 according to the search type, assigns priorities to the content items, and outputs the content items according to the priorities. In detail, the information search unit 150 includes a plurality of type-based search agents 151, a search type determining unit 152, a search agent management unit 153, and a search result output unit 154.

The type-based search agent 151 is a search software module for performing type-based search with reference to the index information database 110. For example, the type-based search agent 151 may be a search software module for performing search using the initial phoneme of the query, which are analyzed by the query analysis unit 140, or a software module for performing search using a word which is in a pre-determined range of the query, which is analyzed by the query analysis unit 140, etc. Since the search software modules for performing type-based search are well-known in the related art, detailed descriptions thereof will be omitted.

The search type determining unit 152 determines a search type according to the results of the analysis. That is, the search type determining unit 152 determines whether to perform search using the initial phoneme of the query, whether to perform search using a word which is in a predetermined range of the query, or whether to perform search using a different method. Here, the search type determining unit 152 can determine a plurality of search types including a search type using the initial phoneme(s) of a query, a search type using a word which is in a predetermined range of a query, etc. The search types are also well-known in the related art, and accordingly, detailed descriptions thereof will be omitted.

The search agent management unit 153 executes and manages a search agent 151 corresponding to the search type which is determined by the search type determining unit 152. If the search type determining unit 152 determines a plurality of search types, the search agent management unit 153 executes and manages the plurality of search agents 151.

The search result output unit 154 determines priorities for the results of the search by the type-based search agent 151, and outputs the results of the search according to the priorities. For example, the search result output unit 154 assigns priorities to the results of the search, and outputs the results of the search according to the priorities. For example, if the type-based search agent 151 is executed under the management of the search agent management unit 153 and the results of the search for the query “tower” are “tower palace”, “seoul tower”, “star tower”, “world tower”, and “prima tower building”, the search result output unit 154 assigns priorities to “tower palace”, “seoul tower”, “star tower”, and “world tower” and sequentially outputs “tower palace”, “seoul tower”, “star tower”, and “world tower” according to the priorities. A method of assigning priorities to the results of the search is well-known in the related art, and accordingly, a detailed description thereof will be omitted.

The search result display unit 160 displays the results of the search, which are output from the information search unit 150, provides a user interface for allowing a user to select a content item from among the results of the search, and receives the content item selected by the user through the user interface. At this time, it is preferable that the search result display unit 160 displays the results of the search on a screen according to the priorities.

The content providing unit 170 reads content corresponding to the content item, from the content database 120, and provides the content. That is, if the results of the search are output according to the priorities, a user selects his or her desired content item from among the results of the search. Since each content item included in the results of the search is linked with content stored in the content database 120, the user can easily obtain his or her desired content by only selecting his or her desired content item. Therefore, according to the present invention, by organically combining an information search technique with a content providing technique, a user can easily and quickly access his or her desired content.

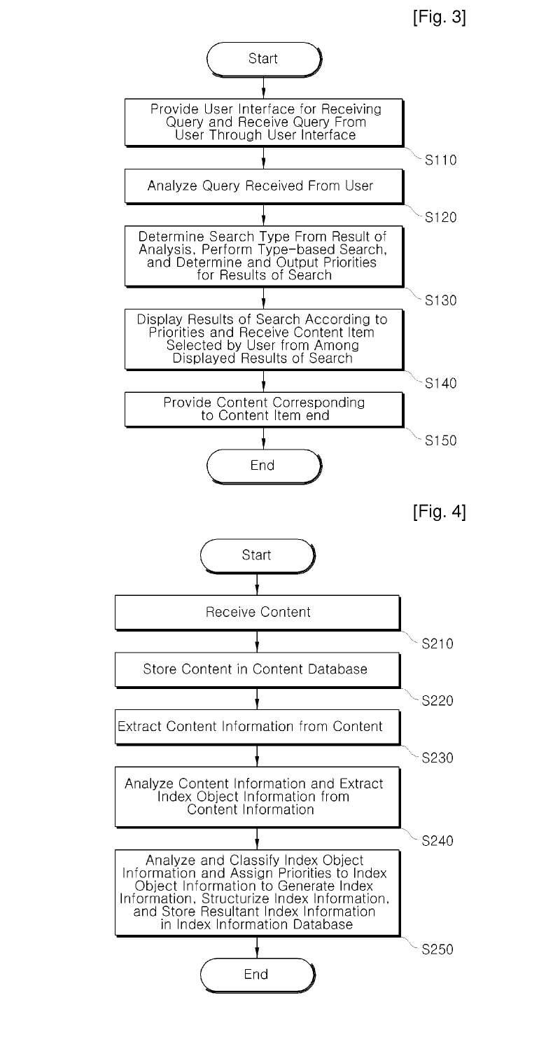

A content search method which is performed by the content search system constructed above will be described with reference to FIG. 3, below. FIG. 3 is a flowchart of a content search method according to an embodiment of the present invention which is performed by the content search system illustrated in FIG. 2. Referring to FIGS. 2 and 3, first, in operation S110, the content search system provides a user interface (UI) for allowing a user to input a query through the query input unit 130, and receives the query from the user through the user interface.

Then, in operation S120, the content search system analyzes the query input by the user.

Thereafter, in operation S130, the content search system determines a search type on the basis of the results of the analysis, searches for content items corresponding to the query from the index information database 110 according to the search type, determines priorities for the content items, and outputs the content items according to the priorities.

Then, in operation S140, the content search system displays the content items according to the priorities through the search result display unit 160, and receives a content item which is selected by a user from among the displayed content items.

Next, in operation S150, the content search system reads content corresponding to the selected content item from the content database 120, and provides the content, through the content providing unit 170, so that the user can easily access the content.

Meanwhile, according to another embodiment of the present invention, the content search system can further include a content input unit 180, a content storage unit 190, a content information extractor 200, a content information analysis unit 210, and an index information processor 220.

The content input unit 180 receives content. The content input unit 180 provides a user interface for allowing a user to input content, and receives the content from the user through the user interface.

Meanwhile, the content input unit 180 can provide a user interface for accessing a server and downloading content from the server, and a user can selectively download content from the server through the user interface. Also, the content input unit 180 can automatically update content through the server.

The content storage unit 190 stores in the content database 120 various online contents, such as music information of MP3, map information of a navigation system, word information of an electronic dictionary, moving picture information, telematics information, ubiquitous information, etc., which are received by the content input unit 180.

The content information extractor 200 extracts content information from the content which is input by the content input unit 180. For example, if the content is MPEG4-based moving picture content, since MPEG7-based content information is included in the MPEG4-based moving picture content, the content information extractor 200 can extract content information from the moving picture content. A method of extracting content information from content data is well-known in the related art, and accordingly, a detailed description thereof will be omitted.

The content information analysis unit 210 analyzes the content information and extr acts index object information from the content information. In detail, the content information analysis unit 210 includes a syntactic analysis unit 211 and a division analysis unit 212. The syntactic analysis unit 211 performs syntactic analysis on the content information. A syntactic analysis method is well-known in the related art, and accordingly, a detailed description thereof will be omitted. The division analysis unit 212 analyzes the content information by dividing the content information into pieces. A method of dividing and analyzing content information is well-known in the related art, and accordingly, a detailed description thereof will be omitted.

For example, if the content information is “seoul star tower”, the content information “seoul start tower” is subjected to morphological-analysis by the syntactic analysis unit 211, so that morphemes “seoul”, “star” and “tower” are extracted as index object information, and successively, is subjected to N-gram analysis by the division analysis unit 212, so that “Seoul”, “oulstar”, “starto”, “tower”, “seoulstar”, “oulstarto”, . . . , “seoulstartower” are extracted as index object information for the full-text.

The index information processor 220 analyzes and classifies the index object information and assigns priorities to the index object information to thus generate index information, and then structurizes the index information and stores the resultant index information in the index information database 110. A method of analyzing and classifying index object information and assigning priorities to the index object information is well-known in the related art, and accordingly, a detailed description thereof will be omitted.

Therefore, the present invention stores content input by the content input unit 180 in the content database 120 through the content storage unit 190, extracts content information from the content through the content information extractor 200, analyzes the content information using the content information analysis unit 210 to extract index object information from the content information by the index information processor 220, analyzes and classifies the index object information and assigns priorities to the index object information to generate index information through the index information processor 220, structurizes the index information, and stores the resultant index information in the index information database 110, thereby databasing the content and index information.

An index information storage method which is performed by the content search system will be described with reference to FIG. 4, below. FIG. 4 is a flowchart of an index information storage method according to an embodiment of the present invention which is performed by the content search system according to the present invention. Referring to FIGS. 2 and 4, first, in operation S210, the content search system receives content through the content input unit 180. Then, in operation S220, the content search system stores the content in the content database 120.

Then, in operation S230, the content search system extracts content information from the content through the content information extractor 200. Successively, in operation S240, the content search system analyzes the content information and extracts index object information from the content information through the content information analysis unit 210. Then, in operation S250, the index information processor 220 analyzes and classifies the index object information and assigns priorities to the index object information to generate index information, structurizes the index information, and stores the resultant index information in the index information database 110. Therefore, the index information database 110 and the content database 120 are established according to the index information storage method, and referred to by the content search system which allows a user to easily access content, when the content search system searches for content from a user's query.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

According to the present invention, it is possible to correctly and quickly search for a large amount of information in a portable personal information terminal.

What is claimed is:

1. An information terminal equipped with a content search system, including:
a manipulation unit allowing a user to input a query; a display unit displaying a search result and content; a memory storing an index information database storing index information and a content database storing content; and a controller controlling the information terminal, executing the content search system to search for content items for the query received from the user through the manipulation unit, and displaying the content items through the display unit, wherein the content search system comprises:
a query input unit providing a user interface for the user to input the query, and receiving the query from the user through the user interface;
a query analysis unit analyzing the query received from the user;
an information search unit including a plurality of type-based search agents for performing type-based search with reference to the index information database, a search type determining unit determining a search type from the result of the analysis, a search agent management unit executing and managing a type-based search agent corresponding to the search type, and a search result output unit assigning priorities to content items searched by the type-based search agent and outputting the content items according to the priorities;
a search result display unit displaying the content items according to the priorities, providing a user interface for the user to select a content item from among the content items, and receiving the content item selected by the user; and a content providing unit reading corresponding to the content and providing the content.

2. The information terminal of claim 1, wherein the content search system further comprises:
a content input unit receiving content from the user;
a content storage unit storing the content received from the content input unit in the content database;
a content information extracting unit extracting content information from the content;
a content information analysis unit analyzing the content information, and extracting target index information from the content information;
and an index information processing unit analyzing and classifying the target index information and assigning priorities to the target index information to generate index information, structurizing the index information, and storing the structurized index information in the index information database.

3. The information terminal of claim 2, wherein the content information analysis unit comprises:
a syntax analysis unit performing syntactic analysis on the content information;
and a division analysis unit dividing and analyzing the content information.

4. The information terminal of claim 2, wherein the content input unit provides a user interface for the user to input the content, and receives the content from the user through the user interface.

5. The information terminal of claim 2, wherein the content input unit provides a user interface for the user to access a server and downloads content selected by the user through the user interface from the server.

6. The information terminal of claim 2, wherein the content input unit automatically updates content through the server.

7. The information terminal of claim 3, wherein the content input unit provides a user interface for the user to input the content, and receives the content from the user through the user interface.

8. The information terminal of claim 3, wherein the content input unit provides a user interface for the user to access a server and downloads content selected by the user through the user interface from the server.

9. The information terminal of claim 3, wherein the content input unit automatically updates content through the server.
